(19) United States
(12) Patent Application Publication
(10) Pub. No.: US 2011/0148734 A1
(43) Pub. Date: Jun. 23, 2011

(54) CABLE CONNECTION PIN AND EMBEDDED ANTENNA TYPE ELECTRONIC DEVICE HAVING THE SAME

(75) Inventors: Chan Gwang AN, Suwon (KR); Jae Suk SUNG, Yongin (KR); Sung Eun CHO, Suwon (KR); Ha Ryong HONG, Hwaseong (KR); Chang Mok HAN, Cheonan (KR); Ki Won CHANG, Suwon (KR); Dae Kyu LEE, Suwon (KR)

(73) Assignee: SAMSUNG ELECTRO-MECHANICS CO., LTD., Suwon (KR)

(21) Appl. No.: 12/880,589

(22) Filed: Sep. 13, 2010

(30) Foreign Application Priority Data
Dec. 23, 2009 (KR) 10-2009-0130054

(51) Int. Cl. H01Q 1/40; H01R 13/02

(52) U.S. Cl. 343/873; 439/884

(57) ABSTRACT

A cable connection pin includes: support portions supported by an injection-molded face; a first receiving rack formed to extend from the support portion and receiving one side of a cable; and a second receiving rack receiving the opposite side of the cable.

### CROSS-REFERENCE TO RELATED APPLICATIONS

This application claims the priority of Korean Patent Application No. 10-2009-0130054 filed on Dec. 23, 2009, in the Korean Intellectual Property Office, the disclosure of which is incorporated herein by reference.

### BACKGROUND OF THE INVENTION

1. Field of the Invention

The present invention relates to a cable connection pin capable of stably connecting a connection terminal part of an antenna embedded in a case of an electronic device and a cable, and an embedded-antenna type electronic device having the cable connection pin.

2. Description of the Related Art

Electronic devices, i.e., mobile communication terminals such as a mobile phone, a personal digital assistant (PDA), a navigation device, a notebook computer, and the like, are requisite for members of modern societies. Mobile communication terminals are advancing toward having additional functions such as CDMA, wireless LAN, GSM, DMB, and the like, and one of the most important components enabling these functions to be included in these devices is an antenna.

Recently, a scheme for embedding antennas in the interior of a case of an electronic device such as a mobile communication terminal has been proposed.

When a coaxial cable is employed for signal transmission and reception between a connection terminal part of an antenna of a case of an antenna-embedded electronic device and a main printed circuit board (PCB) of the electronic device, the coaxial cable is connected to the PCB and a C-clip connected with the connection terminal part of the antenna is soldered to a signal connection line of the coaxial cable so as to be used.

This scheme, however, has a problem in that material unit cost increases because the PCB is used in order to connect the coaxial cable and the connection terminal part of the antenna.

In addition, the soldering of the C-clip and the coaxial cable lengthens the overall fabrication process, and a high temperature soldering process causes a defective antenna contact point.

### SUMMARY OF THE INVENTION

An aspect of the present invention provides a cable connection pin capable of stably connecting a connection terminal part of a case of an antenna-embedded type electronic device and a cable.

Another aspect of the present invention is to provide an antenna-embedded type electronic device having a connection pin capable of stably connecting a coaxial cable to a case of the antenna-embedded type electronic device.

According to an aspect of the present invention, there is provided a cable connection pin including: support portions supported by an injection-molded face; a first receiving rack formed to extend from the support portion and receiving one side of a cable; and a second receiving rack receiving the opposite side of the one side of the cable.

The cable connection pin may further include: a connection rack connecting the support portions, wherein the plurality of support portions are in contact with a plurality of portions of the injection-molded face and are formed to be flat and have through holes formed thereon to allow connection protrusions protruded from the injection-molded face to pass therethrough.

The first receiving rack, the second receiving rack, or the first and second receiving racks may be connected to only one of the support portions.

The connection rack may be formed to receive one of the one side and the opposite side of the cable.

The first receiving rack, the second receiving rack, and the connection rack may receive one side of the cable, the opposite side of the cable, and one side of the cable, respectively.

The first receiving rack may be in contact with a signal connection line of the cable, and the second receiving rack may include a connection pad in contact with a connection terminal part of an antenna exposed from the injection-molded face.

The connection rack may be in contact with a ground line of the cable.

The first receiving rack, the second receiving rack, or the first and second receiving racks may receive the sheath of the cable.

According to another aspect of the present invention, there is provided an antenna-embedded type electronic device including: a radiator including an antenna pattern part, a connection terminal part, and a connection part connecting the antenna pattern part and the connection terminal part; a radiator frame including the radiator which has been injection-molded such that the antenna pattern part is formed on one surface thereof and the connection terminal part is formed on the opposite side thereof; a case frame covering the radiator frame to bury the antenna pattern part; and a cable connection pin including support portions supportedly in contact with the opposite side where the connection terminal part is formed, and first and second receiving racks formed to receive one side and the opposite side of a cable connected with a main printed circuit board (PCB).

The case frame may be injection-molded by providing a molding liquid on the radiator frame.

The cable connection pin may further include: a connection rack connecting the support portions, wherein the plurality of support portions are in contact with a plurality of portions of the injection-molded face and are formed to be flat and have through holes formed thereon to allow connection protrusions protruded from the injection-molded face to pass therethrough.

The connection protrusions may be fixed in the through holes through thermal binding (or thermal fusion).

The first receiving rack, the second receiving rack, or the first and second receiving racks may be connected to only one planar support portion among the support portions.

The connection rack may be formed to receive one of the one side and the opposite side of the cable in a surrounding manner.

The first receiving rack, the second receiving rack, and the connection rack may receive one side of the cable and receive the opposite side and one side of the cable, respectively.

The first receiving rack may be in contact with a signal connection line of the cable, and the second receiving rack may include a connection pad in contact with a connection terminal part of an antenna exposed from the injection-molded face.

The connection rack may be in contact with a ground line of the cable.

The first receiving rack, the second receiving rack, or the first and second receiving racks may receive the sheath of the cable.

The cable may be a coaxial cable.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a notebook computer, an antenna-embedded type electronic device whose case is partially cutaway to show an antenna according to an exemplary embodiment of the present invention as magnified;

FIG. 2 is a schematic perspective view showing the connection between the case of the antenna embedded type electronic device and a cable connection pin according to an exemplary embodiment of the present invention;

FIG. 3 is an exploded perspective view schematically showing a connection between the case of the antenna embedded type electronic device and a cable connection pin of FIG. 2;

FIG. 4 is a perspective view of the cable connection pin according to an exemplary embodiment of the present invention;

FIG. 5 is a bottom perspective view of the cable connection pin of FIG. 4;

FIG. 6 is an elevation view of the cable connection pin viewed in direction ‘A’ of FIG. 4; and

FIG. 7 is a schematic perspective view showing the cable connection pin fixed to the antenna embedded-type electronic device case through thermal bonding according to an exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

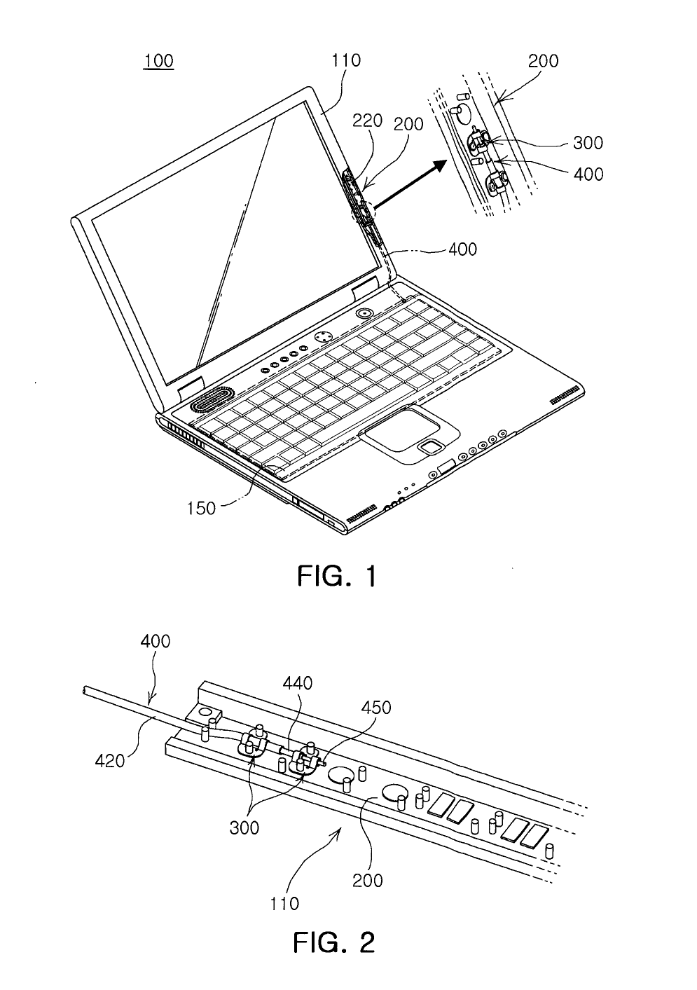

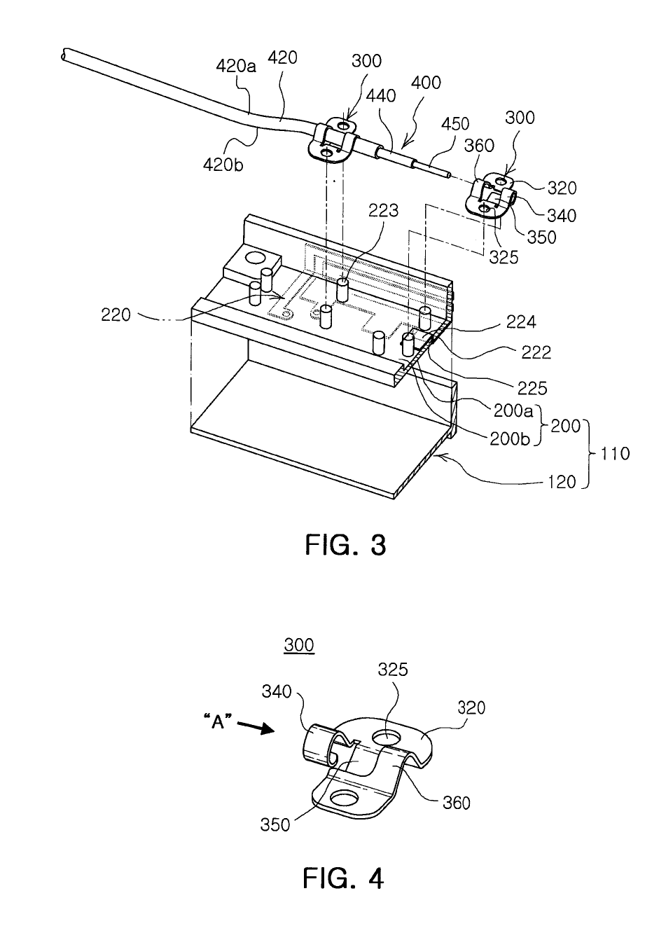

FIG. 1 illustrates a notebook computer, an antenna-embedded type electronic device whose case is partially cutaway to show an antenna as magnified according to an exemplary embodiment of the present invention. FIG. 2 is a schematic perspective view showing the connection between the case of the antenna embedded type electronic device and a cable connection pin according to an exemplary embodiment of the present invention. FIG. 3 is an exploded perspective view schematically showing a connection between the case of the antenna embedded type electronic device and a cable connection pin of FIG. 2.

With reference to FIGS. 1 to 3, the antenna-embedded type electronic device may include a radiator 220, a radiator frame 200, a case frame 120, and a cable connection pin 300.

In the present exemplary embodiment, a notebook computer 100 (or a laptop computer) is illustrated as the electronic device, but the present invention is not limited thereto and any electronic device can be used so long as it needs to be connected to a cable 400 for a signal transmission and reception of a main printed circuit board (PCB) 150 and the radiator 220.

Here, the cable 400 may be a coaxial cable and include a signal transmission line 450, a core wire of an external sheath 420, and a ground line 440 formed on an outer circumferential surface of the signal transmission line 450.

The radiator 220 may include an antenna pattern part 222, a connection terminal part 224, and a connection part 225 connecting the antenna pattern part 222 and the connection terminal part 224.

The radiator 220 may have a structure in which the antenna pattern part 222, the connection terminal part 224, and the connection part 225 are formed integrally, or may have a structure in which the connection part 225 and the connection terminal part 224 are separated from the antenna pattern part 222.

The antenna pattern part 222 may have a meander pattern in order to have a length according to a signal band. The connection terminal part 224 may be connected with the cable 400 for a signal exchange between the antenna pattern part 222 and the main PCB 150.

Meanwhile, the radiator 220 is injection-molded so that the antenna pattern part 222 is formed on one side 200a of the radiator frame 200 and the connection terminal part 224 may be connected with the opposite side 200b of the one side 200a.

The radiator frame 200 is covered by the case frame 120 of the notebook computer 100 to become an electronic device case 110 with the antenna pattern part 222 embedded therein.

The case frame 120 may be an injection-molded product separate from the radiator frame 200, and may be formed by putting the radiator frame 200 in an injection mold of the electronic device case 110, providing a molding liquid on one side 200a of the radiator frame 200, and injection-molding the same. Namely, dual-injection molding is performed to form the electronic device case 110 having the antenna pattern part 222 embedded therein.

The case connection pin 300 may be fixed to the opposite side 200b of the radiator frame 200 from which the connection terminal part 224 is exposed, in order to fix the cable 400.

The case connection pin 300 may be configured to have all the technical features to be described hereinafter.

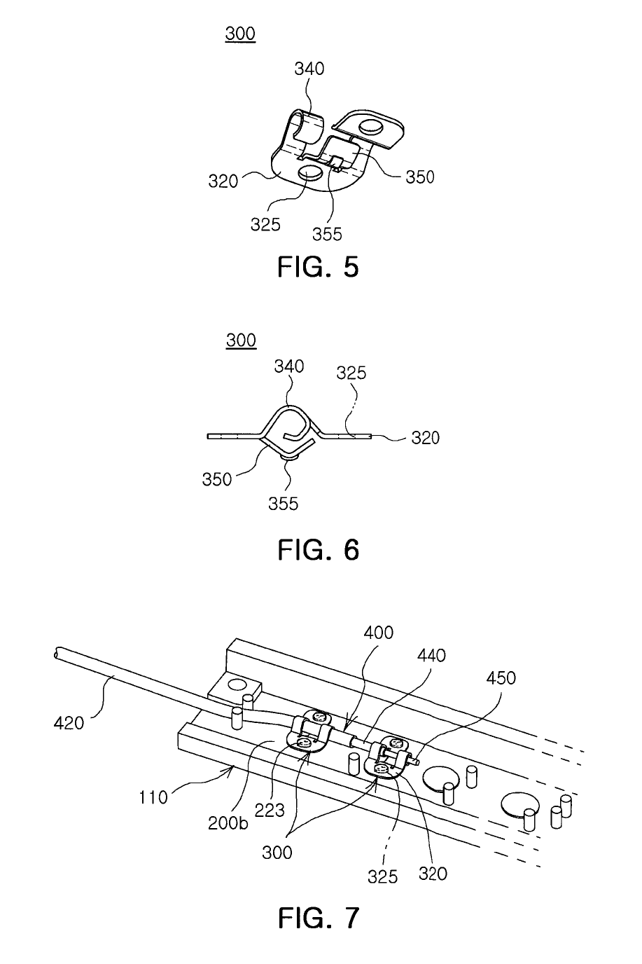

FIG. 4 is a perspective view of the cable connection pin according to an exemplary embodiment of the present invention. FIG. 5 is a bottom perspective view of the cable connection pin of FIG. 4. FIG. 6 is an elevation view of the cable connection pin viewed in direction ‘A’ of FIG. 4.

With reference to FIGS. 4 to 6, the cable connection pin 300 according to an exemplary embodiment of the present invention may include a support portion 320, a first receiving rack 340, and a second receiving rack 350.

The support portion 320 is in contact with the injection-molded face, namely, the opposite side 200b of the radiator frame 200, so as to be supported. Provided that the first receiving rack 340 and the second receiving rack 350 in which the cable 400 is coupled are provided, one or a plurality of support portions 320 may be configured.

The cable connection pin 300 may be fabricated by performing a drawing process on a metal plate having elasticity and, in this case, the metal plate may be cut to form the first receiving rack 340 and the second receiving rack 350 extending from the support portion 320. Here, the first receiving rack 340, the second receiving rack 350, or the first and second receiving racks 340 and 350 may be connected by only one of the plurality of support portions 320.

The cable connection pin 300 according to the present exemplary embodiment includes two support portions 320 in contact with two portions of the injection-molded face.

The two support portions 320 of the cable connection pin 300 may be connected by a connection rack 360. The first and second receiving racks 340 and 350 are connected with only one support portion 320 in order to encircle the cable 400, and are cut away (i.e., separated) from another support portion 320.

As shown in FIG. 2, the first receiving rack 340 may be configured to receive one side 420a of the cable 400, and the second receiving rack 350 may be configured to receive the opposite side 420b of one side 420a of the cable 400.

The first receiving rack 340 and the second receiving rack 350 may fixedly wrap the cable 400 by using their elasticity.

The connection rack 360 may also have a round shape in order to receive one of the one side 420a and the opposite side 420b of the cable 400.

The first receiving rack 340, the second receiving rack 350, and the connection rack 360 may be configured to receive one side 420a, the opposite side 420b, and one side 420a along a lengthwise direction of the cable 400.

In this case, the first receiving rack 340, the second receiving rack 350, and the connection rack 360 may receive the sheath 420 of the cable 400. Also, as shown in FIG. 3, the cable connection pin 300 may connect the cable 400 to the connection terminal part 224 exposed from the opposite side 200b of the frame 200 by the first receiving rack 340, the second receiving rack 350, and the connection rack 360.

In this case, the first receiving rack 340 may be in contact with the signal transmission line 450 of the cable 400. The second receiving rack 350 may include a connection pad 355 in contact with the connection terminal part 224 of the radiator 220 exposed from the opposite side 200b of the radiator frame 200.

The connection rack 360 may be in contact with the ground line 440 of the cable 400 so as to discharge noise generated from an antenna toward the main PCB 150 illustrated in FIG. 1.

FIG. 7 is a schematic perspective view showing the cable connection pin fixed to the antenna embedded-type electronic device case through thermal bonding according to an exemplary embodiment of the present invention.

The support portions 320 of the cable connection pin 300 may have through holes 325 allowing connection protrusions 223 protruded from the opposite side 200b of the radiator frame 200 to pass therethrough.

After the connection protrusions 223 are inserted in the through holes 326 of the support portions 320, portions of the connection protrusions 223 protruded from the upper portion of the through holes 325 are thermally fused to thus firmly fixing the cable connection pin 300 on the opposite side 200b of the radiator frame 200.

As so far described, the cable connection pin and the electronic device having the same according to an exemplary embodiment of the present invention have the following advantages. That is, no PCB is used for connecting the coaxial cable to the connection terminal part, so the number of components can be reduced.

Also, because the number of components is reduced, the material cost can be reduced and the fabrication process can be simplified.

In addition, because the fixing protrusions are thermally fused at a relatively low temperature compared with soldering to fix the cable connection pin, a defective antenna contact point can be reduced.

As set forth above, in the cable connection pin and the electronic device having the cable connection pin, because the connection terminal part is connected to the coaxial cable without using a printed circuit board (PCB), the number of components can be reduced.

The reduction in the number of components can lower the material cost and simplify the fabrication process.

In addition, because the fixing protrusions are thermally fused (or bonded) at a relatively low temperature compared to soldering to fix the cable connection pin, a defective antenna contact point can be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A cable connection pin comprising:
support portions supported by an injection-molded face;
a first receiving rack formed to extend from the support portion and receiving one side of a cable; and
a second receiving rack receiving the opposite side of the one side of the cable.

2. The cable connection pin of claim 1, further comprising:
a connection rack connecting the support portions,
wherein the plurality of support portions are in contact with a plurality of portions of the injection-molded face and are formed to be flat and have through holes formed thereon to allow connection protrusions protruded from the injection-molded face to pass therethrough.

3. The cable connection pin of claim 2, wherein the first receiving rack, the second receiving rack, or the first and second receiving racks are connected to only one of the support portions.

4. The cable connection pin of claim 2, wherein the connection rack is formed to receive one of the one side and the opposite side of the cable.

5. The cable connection pin of claim 2, wherein the first receiving rack, the second receiving rack, and the connection rack receive one side of the cable, the opposite side of the cable, and one side of the cable, respectively.

6. The cable connection pin of claim 1, wherein the first receiving rack is in contact with a signal connection line of the cable, and the second receiving rack comprises a connection pad in contact with a connection terminal part of an antenna exposed from the injection-molded face.

7. The cable connection pin of claim 6, wherein the connection rack is in contact with a ground line of the cable.

8. The cable connection pin of claim 1, wherein the first receiving rack, the second receiving rack, or the first and second receiving racks receive the sheath of the cable.

9. An antenna-embedded type electronic device comprising:
a radiator including an antenna pattern part, a connection terminal part, and a connection part connecting the antenna pattern part and the connection terminal part;
a radiator frame including the radiator which has been injection-molded such that the antenna pattern part is formed on one surface thereof and the connection terminal part is formed on the opposite side thereof;
a case frame covering the radiator frame to bury the antenna pattern part; and
a cable connection pin including support portions supportedly in contact with the opposite side where the connection terminal part is formed, and first and second receiving racks formed to receive one side and the opposite side of a cable connected with a main printed circuit board (PCB).

10. The electronic device of claim 9, wherein the case frame is injection-molded by providing a molding liquid on the radiator frame.

11. The electronic device of claim 9, wherein the cable connection pin further comprises:
a connection rack connecting the support portions,
wherein the plurality of support portions are in contact with a plurality of portions of the opposite side and are formed to be flat and have through holes formed thereon to allow connection protrusions protruded from the opposite side to pass therethrough.

12. The electronic device of claim 11, wherein the connection protrusions are fixed in the through holes through thermal binding.

13. The electronic device of claim 11, wherein the first receiving rack, the second receiving rack, or the first and second receiving racks are connected to only one planar support portion among the support portions.

14. The electronic device of claim 13, wherein the connection rack is formed to receive one of the one side and the opposite side of the cable in a surrounding manner.

15. The electronic device of claim 13, wherein the first receiving rack, the second receiving rack, and the connection rack receive one side of the cable, the opposite side of the cable, and one side of the cable, respectively.

16. The electronic device of claim 9, wherein the first receiving rack is in contact with a signal connection line of the cable, and the second receiving rack comprises a connection pad in contact with a connection terminal part of an antenna exposed from the injection-molded face.

17. The electronic device of claim 16, wherein the connection rack is in contact with a ground line of the cable.

18. The electronic device of claim 9, wherein the first receiving rack, the second receiving rack, or the first and second receiving racks receive the sheath of the cable.

19. The electronic device of claim 9, wherein the cable is a coaxial cable.
